(19) United States
(12) Patent Application Publication
(10) Pub. No.: US 2026/0359553 A1
(43) Pub. Date: Nov. 12, 2026

(54) NLP TECHNIQUES FOR DOCUMENT SEGMENTATION AND CLASSIFICATION

(71) Applicant: Medscrios LLC, Fort Collins, CO (US)

(72) Inventor: Jeremy D. Slater, Fort Collins, CO (US)

(21) Appl. No.: 19/205,377

(22) Filed: May 12, 2025

(51) Int. Cl. G06F 40/166; G06F 40/40; G06V 30/413; G06V 30/414; G06V 30/42

(52) U.S. Cl. CPC G06F 40/166; G06F 40/40; G06V 30/413; G06V 30/414; G06V 30/42

(57) ABSTRACT

The techniques may include accessing an input media file. In addition, the techniques may include segmenting the input media file into a sequence of segmented media portions that has a predetermined ordinal relationship between each segmented media portion of the sequence of segmented media portions. The techniques may include for each segmented media portion: identifying the segmented media portion based on the predetermined ordinal relationship; providing, as input to a generative language model, the segmented media portion, a prompt, and a context when present; receiving an output from the model; adding the output of the generative language model to a summary of the input media file; and updating the context based at on the output of the generative language model for input to a next segmented media portion of the segmented media portions. Moreover, the techniques may include outputting the summary of the input media file.

### BACKGROUND

Natural language processing (NLP) techniques can allow for a semantic analysis of text documents. Natural language processing tools can perform coarse categorization, but natural language processing techniques can struggle in processing long documents, particularly in scientific fields. Accordingly, improvements to natural language processing techniques are desirable.

### SUMMARY

An artificial intelligence (AI) framework can use one or more machine learning models, such as generative language models, to provide a natural language processing (NLP) evaluation of a document having certain properties (e.g., manuscript). For example, a manuscript, such as a scientific paper, may be organized into different sections, e.g., in a predetermined ordinal relationship. This order allows the AI framework (e.g. the document system) to use the context from a previous section (e.g., a segment-context) as input to generate an analysis of subsequent sections. For example, the AI framework may use input from a paper's methods section when generating an evaluation of the paper's conclusion section.

The AI framework may employ various techniques to evaluate a manuscript. For example, the AI framework may access an input media file that includes the manuscript. The techniques performed by the AI framework may also include segmenting the input media file into a sequence of segmented media portions. The AI framework may use a predetermined ordinal relationship between each of the sequence of segmented media portions to identify each segmented media portion in an order that is. based on the predetermined ordinal relationship. The AI framework can use the order to provide input to a generative language model. In various techniques, the input can include the segmented media portion, a prompt, and a context when present. The AI framework can receiving an output from the generative language model, and the framework can add the output of the generative language model to a summary of the input media file. The AI framework can use the output of the generative language model to update the context for input to a next segmented media portion of the segmented media portions, and the summary of the input media file can be output.

Other embodiments of these techniques include corresponding methods, computer systems, apparatus, and computer programs recorded on one or more non-transitory computer storage devices, each configured to perform the actions of the techniques.

A better understanding of the nature and advantages of embodiments of the present disclosure may be gained with reference to the following detailed description and the accompanying drawings.

### BRIEF DESCRIPTION OF THE DRAWINGS

FIG. 1 is a simplified diagram of an architecture for document segmentation and evaluation in accordance with at least one embodiment.

FIG. 2 shows an example system architecture 200 according to at least one embodiment.

FIG. 3 shows a sequence diagram for document segmentation and evaluation according to at least one embodiment.

FIG. 4 is a block diagram illustrating an example method for document segmentation and evaluation, in accordance with at least one embodiment.

FIG. 5 shows a simplified diagram of a computer system in accordance with at least one embodiment.

### TERMS

A “machine learning model” (ML model) can refer to a software module configured to be run on one or more processors to provide a classification or numerical value of a property of one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, or one million parameters. An ML model can be generated using sample data (e.g., training samples) to make predictions on test data. Various number of training samples can be used, e.g., at least 10, 100, 1,000, 5,000, 10,000, 50,000, 100,000, or at least 200,000 training samples. One example is an unsupervised learning model. Another example type of model is supervised learning that can be used with embodiments of the present disclosure. Example supervised learning models may include different approaches and algorithms including analytical learning, statistical models, artificial neural network (e.g. including convolutional and/or transformer layers), boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), random forests, ordinal classification, data pre-processing, handling imbalanced datasets, statistical relational learning, or Proaftn (a multicriteria classification algorithm), or an ensemble of any of these types. The model may include linear regression, logistic regression, deep recurrent neural network (e.g., long short term memory, LSTM), hidden Markov model (HMM), linear discriminant analysis (LDA), k-means clustering, density-based spatial clustering of applications with noise (DBSCAN), random forest algorithm, support vector machine (SVM), or any model described herein. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

### DETAILED DESCRIPTION

An artificial intelligence (AI) framework can use one or more generative language models to provide a natural language processing (NLP) evaluation of a document having certain properties (e.g., manuscript). For example, a manuscript, such as a scientific paper, may be organized into different sections, e.g., in a predetermined ordinal relationship. This order allows the AI framework (e.g. the document system) to use the context from a previous section (e.g., a segment-context) as input to generate an analysis of subsequent sections. For example, the AI framework may use input from a paper's methods section when generating an evaluation of the paper's conclusion section.

A generative language model can use natural language processing (NLP) techniques to evaluate the manuscript's sections. As each section is provided to the model, the generative language model (e.g., a machine learning model) can perform operations to generate a summary and evaluation for that section (e.g., a segment-evaluation). The document system can provide this segment-evaluation to a summary engine that outputs a final evaluation of the paper, and the system's evaluation engines can use the summary to update a segment-context for each of the paper's sections. This segment-context is a natural language summary of some or all of the sections that have already been analyzed by preceding evaluation engines and the segment-context allows the generative language model in each evaluation engine to analyze a particular section in light of the preceding sections. The segment-context is propagated to each succeeding section's evaluation engines until the paper has been evaluated. Once each section has been analyzed, the document system's summary engine can output the evaluation of the paper that is generated from the segment-evaluations.

### I. Document System Architecture

Manuscript segmentation and evaluation can be performed by a document system. A segmentation engine within the document system can divide the manuscript into sections, and these segments can be sequentially evaluated by the document system's evaluation engines. The evaluation engines can use information about the manuscript's figures and references as input, and this information can be provided to the evaluation engines by image engines and reference engines respectively.

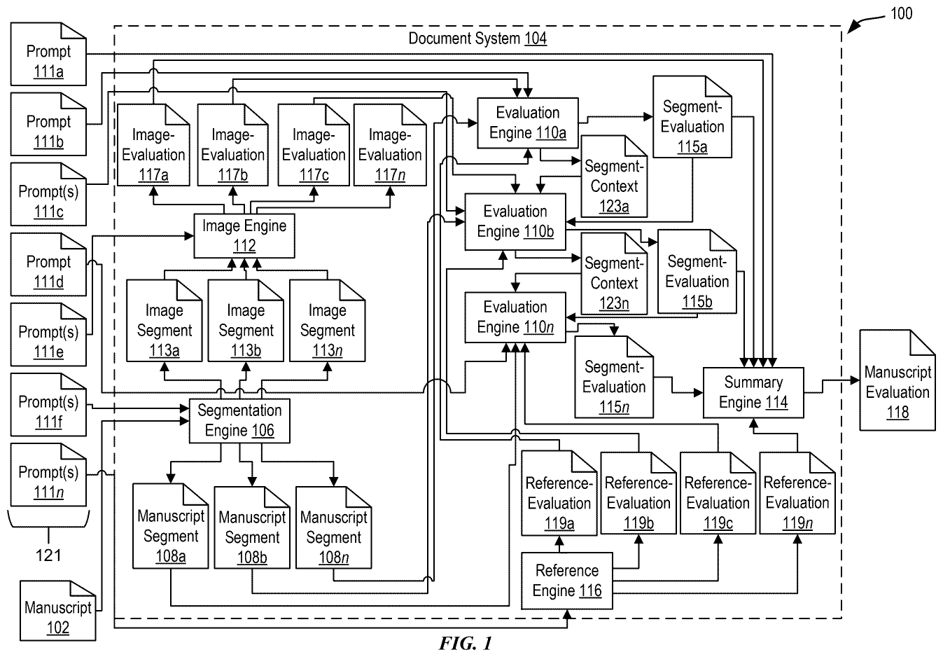

FIG. 1 is a simplified diagram of an artificial intelligence (AI) architecture 100 for document segmentation and evaluation according to at least one embodiment. The manuscript 102 can be a media file (e.g., an input media file) that is to be evaluated by the document system 104. The document system, and any of the engines therein, can be implemented in hardware, in software, or in a combination of hardware and software. The document system may be implemented by a cloud service provider and the disclosed techniques can be offered as part of a multi-tenant software-as-a-service (SaaS) architecture that is accessible via a web browser application. The disclosed techniques can be provided as a service by a cloud service provider and the service can be accessed by subscribers. A media file can include one or more files and the media file can include any combination of a text file, an image file, and a video file. In some embodiments, the manuscript can be a portable document format (PDF) file that includes both text and images.

### A. Manuscript Segmentation

To evaluate a manuscript, the document system can use heuristic techniques to segment the manuscript 102 into different sections. For example, the AI framework (e.g., document system 104) can store a list of template titles for each section heading. The templates can include textual and visual characteristics of the titles (e.g., size, font, color, etc.). The AI framework can instruct a generative language model to identify the coordinates of section headings that match these templates, and the coordinates (e.g., pixel identifiers, page numbers, x-y coordinates, etc.) can be used to segment the manuscript. The identified section headings can be used to determine a particular order for analyzing the manuscript sections. This evaluation order may differ from the sequential order of the manuscript's sections. For example, the methods section may be at the manuscript's end, but the section may be relevant to understanding a results section that precedes the methods section.

As shown in FIG. 1, the manuscript 102 can be divided into manuscript segments (e.g., segmented media portions) by the segmentation engine 106. The segmentation engine 106 can recognize text that matches one or more of the templates and the matching text can be used to recognize the boundaries of different manuscript segments 108a-108n. For example, the segmentation engine 106 can identify text that matches the template “ABSTRACT” to recognize the beginning of the abstract segment. This abstract segment can extend from the keyword until the beginning of the next segment in the manuscript 102. The segmentation engine 106 can use the matching text to assign an identifier to manuscript segments 108a-108n. The segmentation engine may use optical character recognition techniques to identify text in an input manuscript 102, or the manuscript 102 may include textual information. In various embodiments, the manuscript segments 108a-108n can each be a contiguous section of text from the manuscript 102.

The template can include visual information as well as textual information to recognize boundaries between segments. For example, the segmentation engine 106 can use the visual characteristics of a heading to identify potential headings, and the textual characteristics can be used for confirmation or to identify specific segments (e.g., conclusion). Continuing the example from above, the segmentation engine 106 can identify “ABSTRACT” as a potential heading because the text is in bold with small capital letters. The segmentation engine 106 can confirm that “ABSTRACT” is a section heading because the headings textual information (e.g., “abstract”) matches a template.

The segmentation engine 106 can extract visual information that includes text size, the font size, the text color, and the text position of text within the manuscript 102. This visual information can be compared against templates to identify potential headings that identify different segments. In some embodiments, text with visual information that contrasts with the surrounding text may be identified as a section heading even if this contrasting visual information is not associated with a template. In some embodiments, the document system can provide a graphical user interface that displays the manuscript 102, and user input can be used to segment the manuscript to generate manuscript segments 108a-108n.

### B. Segment-Evaluation

Segment-evaluations 115a-115n can be a model generated summary and analysis of a particular manuscript segment (e.g., manuscript-segments 108a-108n). The summary can be a condensed version of the text in the manuscript section, and the summary can be generated by an evaluation engine's machine learning model. The analysis can be answers to questions about the manuscript section that are provided to the evaluation section's machine learning model. In various embodiments, a segment-evaluation can include an analysis, a summary, or an analysis and summary.

The segmentation engine 106 can use the label for each manuscript segment 108 to forward the segments to an evaluation engine 110a-110n. For example, the segmentation engine 106 may create a table during segmentation that includes a mapping of each manuscript segment to a label. The segmentation engine 106 may assign the labels by matching the headings of each segment to an ordinal list of headings that indicates an order for communicating the manuscript segments to the evaluation engine 110a-110n. In some embodiments, a user can assign labels to each segment. For example, the segmented documents can be presented to a user (e.g., via a user interface of an application or web browser application) and the user can assign labels to each segment. Separate evaluation engines 110a-110n are shown in diagram 100, but the disclosed techniques may be performed by any number of evaluation engines including a single engine. The evaluation engines 110a-110n may analyze the manuscript segments 108 in a particular order (e.g., a predetermined ordinal relationship). The particular order can be a sequential order that is specified in the manuscript (e.g., each section is evaluated in the order in which it appears in the manuscript).

The section categories may be consistent across different manuscripts. For example, manuscript 102 may be a scientific paper that is intended for peer review and publication in a scientific journal. Scientific journals may require specific enumerated sections (e.g., an abstract section, an introduction section, a methods section, and a discussion section) for their publications. However, the order for these sections may vary across manuscripts. For example, a first author may put the abstract in the beginning of the manuscript, and a second author may put the abstract at the end of the manuscript. The manuscript segment 108a-108n can include any combination of an abstract section, an introduction section, a methods section, a results section, and a discussion section.

Regardless of the actual section order in a manuscript, the evaluation engines 110a-110n may evaluate the manuscript segments in a particular order. Continuing the example from above, the evaluation engine may analyze the abstract before evaluating the remainder of the manuscript. Evaluating the segments from each manuscript in a consistent order can result in predictable evaluations across different manuscripts. For example, the evaluation engines 110a-110n may evaluate the manuscript segments 108a-108n in the following order: 1) abstract section, 2) introduction section, 3) methods section, 4) results section, and 5) discussion section. In various embodiments, the evaluation engines 110a-110n may evaluate these segments in any particular order.

A first manuscript segment (e.g., manuscript segment 108a) can be forwarded to the evaluation engine 110a by the document system 104. The evaluation engines 110a-110n can include a generative language model (e.g., a machine learning model). The weights within the generative language model may be frozen and the model may not train on the input data in some embodiments. The manuscript segment 108a may be provided to the evaluation engine 110a as a portion of the manuscript file that was input into the segmentation engine 106 or the manuscript segment 108a may be provided as a text file (e.g., the text extracted by optical character recognition by the segmentation engine 106).

### 1. Prompt Segment Evaluation

The input to the evaluation engines 110a-110n can include a prompt 109. A generative language model can be a machine learning model that is trained to perform natural language processing tasks to generate natural language text in response to an input. The input can include natural language instructions (called prompts 111a-111n) that describe a desired output from the model. For example, the prompt 111b that is provided to an evaluation engine 110a can include instructions that cause the generative language model to summarize a manuscript section. The prompts 111b-111d that are provided to the evaluation engines 110a-110n may also include instructions to analyze various aspects of the manuscript section, and the segment-evaluations 115a-115n output by the generative language models can provide responses to the instructions. Each of the segmentation engine 106, the evaluation engines 110a-110n, the image engine 112, the summary engine 114, and the reference engine 116 may receive the same prompt, or the prompts 111a-111n can be different for some or all of the engines.

The prompt 111a-111n can include a description of a summary for segment-evaluations 115a-115n. For example, the prompt can identify any combination of a word limit, character limit, and language for the segment-evaluation that is output of evaluation engine's model (e.g., “Provide a 500-word English language summary and analysis of the Methods section.”). In some embodiments, the prompt can specify a target audience for the segment-evaluation (“Provide a summary for a college educated audience with a technical degree.”). The prompt 111a-111n can identify a specific area of expertise that the model should use to evaluate the input and to generate the output (e.g., “Provide a summary of the section from the perspective of a cellular biologist with a graduate degree). [0027] Segment-evaluations 115a-115n can include responses to instructions to analyze various aspects of the manuscript segment, and these instructions can be included in a prompt 111a-111n. The prompts 111a-111n may include instructions to provide specific feedback and suggestions for improvement as part of the analysis (e.g., an enumerated list of specific changes to improve the section). The analysis instructions can be different for each manuscript segment. For example, prompt 111a-111n for an abstract section can include instructions to analyze 1) the clarity and conciseness of language used in the abstract, 2) the quality of the abstract's summary of the study's purpose, methods, key findings, and conclusions, and 3) the accessibility of the abstract section's language (e.g., whether the abstract uses jargon or technical terms without embedded explanations). The prompt 111a-111n for an introduction section may include instructions to analyze 1) the clarity and precision of the research problem, 2) the adequacy and relevancy of the literature review, and 3) the organization and logical flow of the section. The prompt 111a-111n for a methods section may include instructions to analyze 1) the research and design methodologies, 2) the section's clarity and conciseness, 3) the materials, equipment, and resources, and 4) the data analysis methods. The prompt 111a-111n for the results section can include instructions to analyze the 1) clarity and precision of the presented data, 2) the tables and figures, 3) the statistical analyses, 4) the consistency with methodology and objectives, and 4) the impartiality of the presented results. The prompt for a discussion section can include instructions to analyze the 1) the thoroughness of connecting the findings to the existing body of literature, 2) the interpretation of the findings, 3) the section's logical flow, 4) the consistency of the discussion with previous studies, 5) the implications and applications of the results, 6) the significance of the results to the field of research, 7) the limitations of the results, and 8) proposed future research.

A prompt 111a-111n may be provided to a generative language model within the summary engine 114. The summary engine's model can use the segment-evaluations 115a-115n of some or all of the manuscript segments to produce a summary and analysis of the entire manuscript 102 (e.g. a manuscript-evaluation). The prompt 111a-111n for the manuscript-evaluation can include instructions to provide 1) an assessment of each manuscript segment, 2) an overall evaluation of the manuscript. The prompt 111a-111n for the manuscript-evaluation may include instructions to analyze 1) the manuscript novelty and scientific contribution 2) the scientific validity and importance, 3) whether revisions are needed. The prompt 111a-111n may instruct the generative language model to identify specific suggested revisions for the manuscript.

### 2. Segment-Context

In addition to a prompt, the input to each evaluation engine 110a-110n may include model generated natural language summaries of some or all of the manuscript 102. These model generated summaries, called segment-context, can provide information about the manuscript 102 that the evaluation engine's model can use to evaluate a particular manuscript segment. For example, a model's segment-evaluation of a results section may be improved if the model is provided with information about the methods that were used to generate these results. Providing segment-context, instead of the entire manuscript 102, can reduce the size of the input to each evaluation engine 110a-110n, because the segment-context may be a condensed evaluation of some or all of the manuscript.

A segment-context can be generated by a segment evaluation 115a-115n (e.g., the output from an evaluation engine). In some embodiments, the segment-context that is input to an evaluation engine (e.g., evaluation engine 110b) can be a segment evaluation (e.g., segment-evaluation 115b) that was output by the preceding evaluation engine (e.g., evaluation engine 110a). Accordingly, a segment-context may not be available for the first manuscript segment that is evaluated because the segment-context may not be generated until at least one manuscript segment has been evaluated by an evaluation engine. An evaluation engine may generate a segment context using image evaluations 117a-117n output by image engine 112 and reference evaluations 119a-119n output by reference engine 116. Image evaluations 117a-117n can include a machine generated plain language summary of one or more of the images from the manuscript 102. The reference evaluations 119a-119n can include a machine generated plan language summary of references identified in the manuscript 102.

The manuscript segment 108a may be provided to the evaluation engine 110a with a prompt 111a-111. In some embodiments, the manuscript segment 108a can be provided with a label identifying the segment (e.g., abstract). The evaluation engine 110a may use the label to identify a prompt 111a-111n for the input manuscript segment 108a from a prompt repository 121. As discussed above, he prompt can be plain language instructions to a generative language model that can cause the model to perform actions identified in the prompt 111a-111n. The prompt 111a-111n can include the same text across the manuscript segments 108 and across different manuscripts 102. However, the prompts 111a-111n may include different text for each manuscript segment. For example, the prompt 111b for an “abstract” section can be different from the prompt 111c for a “methods” section. The prompt may be augmented for each segment by keywords that are provided by the user (e.g., “neuroscience,” and “CRISPR”).

The segment-context can be plain language instructions that cause the model to perform actions identified in the context. A difference between the prompts 111a-111n and the segment-context is that the segment-context is particular to the manuscript 102 and the prompts 111a-111n may include the same text across different manuscripts 102 (e.g., prompt 111c for a first manuscript may have the same text as prompt 111c for a second manuscript). A difference can be that the prompts 111a-111n may be human generated text, but the segment-context can be machine generated text. The prompts 111a-111n and segment-context can be provided as input to the generative language models at the same time or at different times and in any order.

The respective segment-evaluations 115a-115n generated by each evaluation engine 110a-110n can be provided to the summary engine 114. The segment-evaluation 115a for manuscript segment 108a can also be provided by the evaluation engine 110a to an evaluation engine 110b that is to evaluate the next manuscript segment 108b. In some embodiments, the same evaluation engine (e.g., evaluation engine 110a) can evaluate multiple manuscript segments (e.g., manuscript segments 108a-108n) or each manuscript segment may be evaluated by a separate evaluation engine (e.g., evaluation engine 110a evaluates manuscript segment 108a, evaluation engine 110b evaluates manuscript segment 108b, and evaluation engine 110n evaluates manuscript segment 108n). The segment evaluation can be used to generate the segment-context 123a for the next manuscript segment 108b that is to be evaluated by the evaluation engine 110b. For example, evaluation engine 110a can provide the segment evaluation for the manuscript segment 108a to evaluation engine 110b. In some embodiments, the provided segment-evaluation 110a from evaluation engine 110a can be designated as the segment-context 123a that is used by evaluation engine 110b.

In some embodiments, the evaluation engine 110b can use a generative language model to produce segment-context 123n by generating the context, or updating the segment-context 123a, using the provided segment-evaluation 115a. For example, the provided segment-evaluation 115a (e.g., the evaluation of the preceding manuscript segment 108a) can be input to the generative language model in evaluation engine 110b. The generative language model in evaluation engine 110b can be instructed to update an existing segment-context to incorporate information from the input segment-evaluation 115a or the model in evaluation engine 110b can be instructed to summarize (e.g., shorten) the segment-evaluation 115a so that the evaluation can be used as segment-context 123a for the manuscript segment 108b that is to be evaluated by the evaluation engine 110b. For example, a maximum character or word count can be specified for the segment-context 123n and the prompt 111c can instruct the generative language model in evaluation engine 110b to output a segment-context that includes the information from the segment-evaluation 115a without exceeding the character or word limit.

The segment-context 123a-123n can be updated for each manuscript segment 108a-108n until the manuscript 102 has been evaluated. While three evaluation engines 110a-110n are shown for illustrative purposes, any number of evaluation engines are contemplated. The segment-context allows the generative language model to evaluate a manuscript segment in light of information from the preceding (e.g., previously evaluated) segments. The segment-context can improve the quality of the manuscript evaluation 118 with fewer computing resources because the segment-context can provide relevant information about a related manuscript segment without having to provide the entire manuscript segment as input to the generative language model (e.g., in addition to the manuscript segment that is to be evaluated by the model). In this way, the generative language model can evaluate a particular manuscript segment, in light of the relevant information from other manuscript segments, without having to use the amount of computing resources that would be needed to evaluate multiple manuscript segments 108a-108n.

In addition, the evaluation can be performed sequentially for the manuscript segments 108a-108n, and the evaluation pipeline can be interrupted before the entire manuscript evaluation 118 is generated. For example, the prompt 111a-111n can include an instruction that causes the generative language model to determine whether the evaluation should proceed (e.g., “Based on the current segment, should the evaluation proceed to the next segment?”). The decision to proceed can be a binary suggestion or a score that is compared to a threshold. In this way, low quality manuscripts can be rejected without having to dedicate computing resources to evaluate the entire manuscript. The manuscript evaluation 118 can be output from the document system 104, and, for example, the manuscript evaluation 118 can be displayed by a computing device upon which the document system 104 is executing. In some embodiments, the document system 104 can provide the manuscript evaluation 118 to a client device via a network connection.

### 3. Image Evaluation

Evaluating a section may include an analysis or evaluation of the images associated with that section. The evaluation model (e.g., the model within evaluation engines 110a-110n) may receive text-based input, and an image may need to be transformed from a visual representation information into a text-based description of that information before the model can evaluate the image. An image model within image engine 112 can receive images (e.g., image segments 113a-113n) as input and generate a text-based assessment of the image (e.g., image-evaluations 117a-117n) as output. The segmentation engine 106 can identify references to images in the manuscript 102, and the segmentation engine 106 can label each image segment 113a-113n to identify the manuscript segments 108a-108n that reference each image. The image engine 112 can use the labels to forward image-evaluations 117a-117n to evaluation engines 110a-110n that reference each image. [0038] The manuscript 102 can include images and the segmentation engine 106 can identify and extract images from the manuscript (e.g., image segments 113a-113n). The segmentation engine 106 can use a model to identify and classify images or shapes in the manuscript. For example, the images can be set apart from the manuscript's text by a rectangular border line and the segmentation engine 106 can recognize this rectangular border as one or more features, and the segmentation engine 106 can classify the one or more features as corresponding to an image segment 113a-113n. The segmentation engine 106 can generate the image segments 113a-113n by extracting the image using the features (e.g., the recognized border) and the engine can associate the extracted image with the recognized label (e.g., image 3).

The segmentation engine 106 can communicate the image segments 113a-113n to image engine 112. The image engine can use a trained machine learning model to generate a natural language description of the image segments 113a-113n. For example, techniques for implementing the image engine's model are described in the following papers which are incorporated for all purposes: K. Bhunesh, M. Abinesh, S. Narmatha, and J. Kannan, “Unveiling the Power of Image to Text Conversion: Advancements, Challenges, and Applications”, IJRESM, vol. 6, no. 9, pp. 29-37, Sep. 2023, Accessed: Feb. 18, 2025; and Saranya, M., et al. “Image to Text Conversion Using Deep Learning Algorithms: Survey.” 2024 10th International Conference on Advanced Computing and Communication Systems (ICACCS). Vol. 1. IEEE, 2024.

The natural language description of an image segment can be output by the image engine 112 as an image-evaluation 117a-117n. The image engine 112 can communicate some or all of the image-evaluations 117a-117n to evaluation engines 110a-110n and summary engine 114. In some embodiments, multiple image-evaluations 117a-117n can be sent to the same engine and an image evaluation can be sent to multiple engines.

### 4. Reference Evaluation

The evaluation may include an assessment of references within the paper. An author may cite to references to support statements that are made in a manuscript. References may also be cited by an author to provide additional detail about techniques that are described in the manuscript. Cited references can be evaluated to determine, whether the references exist, whether the references support the statements for which they are offered, whether the references were published in high impact journals, whether the references come from the same field of study as the manuscript, etc.

The reference engine 116 can provide an analysis of the references from the manuscript 102 to the summary engine 114. For example, the reference engine 116 can perform a search (e.g., an internet search) to determine whether a referenced document exists. The reference engine 116 can provide a cited passage and the reference as input to a generative language model and the reference engine 116 can provide an assessment of whether the reference supports the proposition for which it is cited. In some embodiments, the reference engine 116 can generate a score for the reference based on any combination of whether the reference was peer reviewed and published (e.g., a peer reviewed status), the quality of the journal where the reference was published (e.g., a publication quality), the number of citations to the reference in other peer reviewed papers (e.g., the impact factor), the number of publications for the reference's authors (e.g., author credentials), a topical relevance, and a paper validity. The reference engine can output the reference evaluation to the summary engine 114. In some embodiments, the reference engine can provide a reference evaluation to some or all of the evaluation engines 110a-110n.

The peer review status can indicate whether the cited work was published in a peer-reviewed publication (e.g., a reputable scientific journal) or is simply a preprint or non-peer-reviewed source. The publication quality can be a value that corresponds to the quality or prestige of the journal or conference where the reference was published. The publication quality may be determined by evaluating journal rankings and acceptance rates. The impact cactor can be based on the number of times the reference itself has been cited in other peer-reviewed papers, the overall impact factor of the journal where the reference is published, and the “h-index” citation metrics of the authors. The author credentials for a paper can be the number and quality of publications by the reference's authors. The topical relevance can indicate whether the reference actually supports the statement being made in the cited passage. This can include assessing whether the content of the reference is in the same discipline or sufficiently relevant to the reference's claims. The reference's validity can be a score that is based on verifying that the reference exists (e.g., checking the cited DOI, publication database, or library catalog) and is accurately represented in the bibliography.

### C. Manuscript Summary

The segment-evaluations 115a-115n output from each evaluation engine 110a-110n can be provided to the summary engine 114. The segment-evaluations 115a-115n can be combined to generate the manuscript evaluation 118. For example, the segment-evaluations 115a-115n can be added in sequential order to a text document to produce the manuscript evaluation 118. The summary engine 114 may shorten or summarize this sequence of segment-evaluations 115a-115n from the evaluation engines 110a-110n to produce the manuscript evaluation 118. In some embodiments, this shortened summary may be included with the segment evaluations, or the shortened summary may be designated as the manuscript evaluation 118 without the segment evaluations.

The engines described with reference to diagrams 100-200 can be implemented in hardware, in software, or in any combination of hardware and software. In some embodiments, the document system 104 can be hosted on one or more server computers or the document system can be implemented locally on a computing device.

### D. Example System Architecture

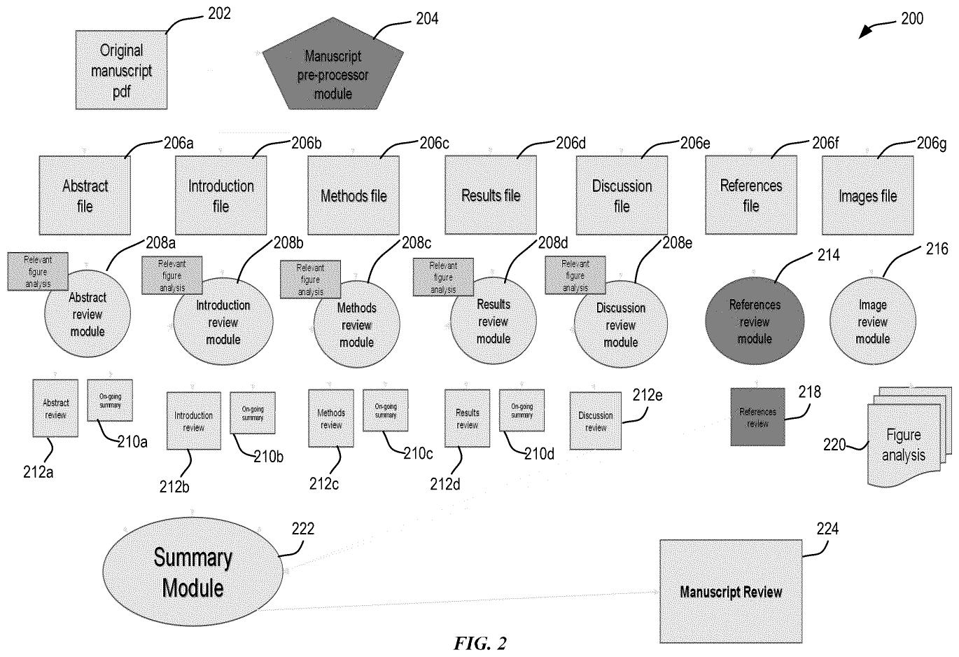

FIG. 2 shows an example system architecture 200 according to at least one embodiment. Original manuscript 202 can be a PDF file of a manuscript that is to be evaluated by the architecture 200. The manuscript preprocessing module 204 (e.g., the segmentation engine 106) can segment the manuscript 202 into segments 206a-206g. The manuscript preprocessing module 204 may perform operations on the original manuscript 202 in addition to segmenting the manuscript. For example, the manuscript preprocessing module may perform optical character recognition techniques to identify text in the manuscript. The preprocessing module may create a text file that includes the recognized text, and this text file may be segmented. In some embodiments, the manuscript preprocessing module 204 may not create separate files for each segment and, for example, the segments may be identified though information that identifies the location of each segment within the original manuscript 202 (e.g., page numbers or pixel coordinates).

The segments 206a-206g can be provided as input to modules (e.g., engines). For example, segments 206a-206e may correspond to manuscript sections (e.g. manuscript-segments) and these segments can be provided as input to evaluation modules that correspond to each manuscript section. These modules can correspond to the evaluation engines 110a-110n that are described with reference to FIG. 1. As shown in architecture 200, evaluation engines 208a-208e can be separate modules, and for example, evaluation engine 208a is an abstract review module, evaluation engine 208b is an introduction review module, evaluation engine 208c is a methods review module, evaluation engine 208d is a results review module, and evaluation engine 208e is a discussion review module.

An evaluation engine can propagate an ongoing summary (e.g., a segment-context) to a subsequent evaluation engine. For example, evaluation engine 208a can provide ongoing summary 210a to evaluation engine 208b. The size of each of the ongoing summaries 210a-210d can vary based on the number of previously evaluated segments and the context may increase in size with each subsequently evaluated segment.

The evaluation modules 208a-208e may generate segment evaluations 212a-212e for some or all of the segments 206a-206e. The evaluation modules 208a-208e may receive input from any combination of reference engine 214 and image engine 216 in some embodiments. The evaluation engines 208a-208e may use the input from the reference engine 214 or the image engine 216 to generate segment-evaluations. The reference engine 214 can provide an analysis of the references that are cited in the original manuscript 202. In some embodiments, the reference engine 214 can use a generative language model to generate a text-based summary the segment-content of some or all of the references. In some embodiments, the reference engine 214 may access or retrieve (e.g., via the internet) an impact score for some or all of the references. The reference evaluation 218 can be provided to the review engines 208a-208e.

The image engine 216 can generate image evaluation(s) 220 for some or all of the images from the original manuscript 202. The image evaluation(s) 220 can be text-based summaries of the images, and the evaluation engines 208a-208e can identify images that are referenced within segments 206a-206e that are input to the engines. An image-evaluation 220 can be retrieved by an evaluation engine if the evaluation engine determines that an image that corresponds to the image-evaluation 220 is referenced in the segment being evaluated by the engine. For example, the evaluation engines 208a-208e can retrieve an image evaluation 220 from the image review module 216.

A summary module 222 can generate a manuscript review 224 for the original manuscript 202. The manuscript review 224 can include any combination of a text-based summary of the original manuscript 202 and an evaluation score for the original manuscript 202. In some embodiments, the manuscript review 224 can include summaries or scores for some or all of the segments 206a-206e.

### II. Sequence Diagram for Document Segmentation and Evaluation

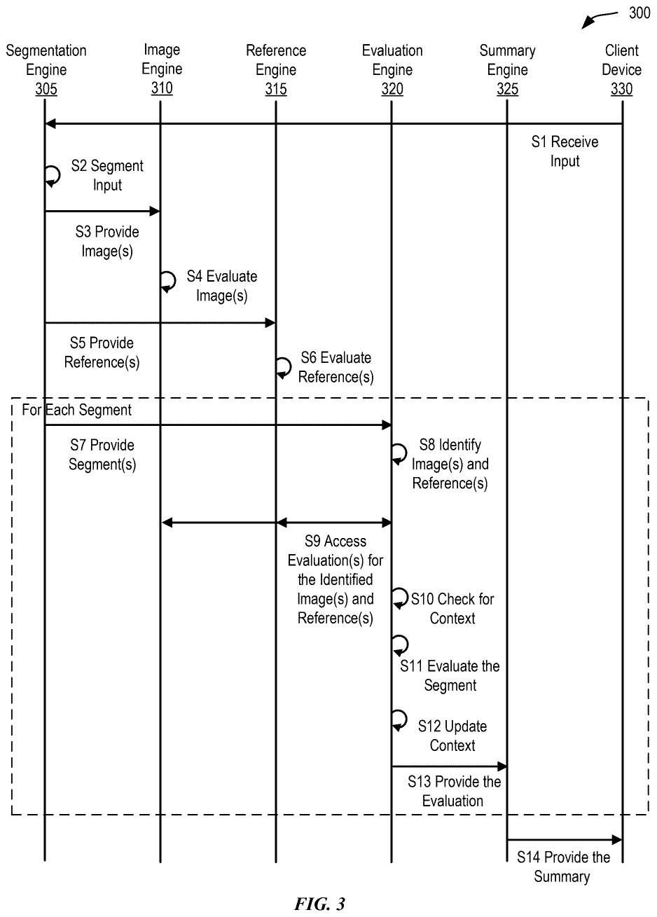

FIG. 3 shows a sequence diagram 300 for document segmentation and evaluation according to at least one embodiment. Techniques can include some or all of the steps shown in diagram 300 and the steps in diagram 300 can be performed any number of times and in any order.

At S1, an input can be received at the segmentation engine 305 from a client device 330. The input can be received over a network connection such as the internet. The input can be a manuscript and the input may be received as a text file, an image file, a word processor file, etc. For example, the input can be a portable document file (PDF) or a device independent file format (DVI). In some embodiments, the input can be provided as a segmented manuscript (e.g., as a plurality of manuscript segments).

At S2, the input file from S1 can be segmented to produce manuscript segment(s) and image segment(s). For example, the segmentation engine 305 can perform optical character recognition techniques to identify section headers, and the text following a section header and preceding a subsequent section header can be designated as a manuscript segment. The manuscript segments produced by the segmentation engine 305 can be text files that are generated separately for each segment. In some embodiments, the segments can be created by dividing the input from S1, and for example, a manuscript segment can be produced from an input PDF file by deleting pages that do not contain the segment. The manuscript segments can include images in some embodiments. In some embodiments, separate image segment(s) can be created for the images. In some embodiments, the input from S1 can be provided as a plurality of manuscript segments and the segmentation engine may not need to segment the manuscript. Segmenting the input from S1 can include identifying images or identifying references in the manuscript in some embodiments.

At S3, the image segment(s) can be provided to the image engine 310. The segmentation engine 305 may identify images, and the identified segment(s) can be provided to the image engine 310 by the segmentation engine 305. In some embodiments, all of the manuscript segment(s), or the manuscript, can be provided to the image engine 310. In some embodiments, segmenting the manuscript may include generating separate image segments for each image.

At S4, the images can be evaluated by the image engine 310. The images can be evaluated by providing the images as input to a machine learning model that is trained to provide a text-based description of an input image segment. In some embodiments, the text-based description of the images can be provided to the segmentation engine 305 or the evaluation engine 320.

At S5, information identifying the references from the input that was received at S1 can be provided to the reference engine 315. The information can be any combination of the text identifying the reference, the text where the reference is cited, and the text of the reference. The reference engine 315 can provide the references as input to a generative language model.

At S6, the reference engine 315 can evaluate the references from S5. In some embodiments, reference engine 315 can use the information identifying the reference to retrieve the reference (e.g., from a database or via an internet search) and the reference can be input to the generative language model. The generative language model can evaluate the reference to determine whether there is an error in the bibliography, whether the reference exists, whether the reference is from the same field as the manuscript that was input at S1 (e.g., biology vs. physics), the number of publications by the authors, the number of references to publications by the authors, the number of citations to the reference, the age of the reference, the impact factor of the publication, and the impact factor of the journal where the reference was published. The reference engine 315 may output any combination of a score for the reference and a text-based evaluation of the reference.

At S7, a segment (e.g., a manuscript segment) that was generated at S2 can be provided to the evaluation engine 320 by the segmentation engine 305. Any number of the segments from S2 may be provided, and the segments may be transformed before the segment is provided. The segment may be provided to the evaluation engine 320 with a prompt. The prompt can be text-based instructions that cause a generative language model to perform one or more actions. In some embodiments, the evaluation engine 320 may access the prompts from a storage device or the evaluation engine may generate the prompts. In some embodiments, S7-S13 can be performed for some or all of the segments generated at S2.

At S8, the images and references that correspond to the segment(s) from S7 can be identified by the evaluation engine 320. The evaluation engine 320 can provide text from the segment(s) from S7 as input to a generative language model and the model can identify references or figures that are identified in the segment(s). Identifying references may involve cross referencing footnote identifiers and a bibliography for the manuscript. The bibliography may be identified by the reference engine 315 and the reference engine may generate a mapping of reference identifiers to references. In various embodiments, the mapping may be accessed before or after S8 (e.g. at S9). The evaluation engine 320 may identify references within a manuscript segment by identifying the reference identifiers in the segment's text. In some embodiments, the references can be identified in information that is provided to the evaluation engine 320 by the segmentation engine in S7.

At S9, the evaluation engine 320 can access evaluation(s) for any image(s) and reference(s) that were identified at S8. The evaluations engine 320 can access reference(s) and image(s) from any combination of the image engine 310, the reference engine 315 and storage device(s) associated with the document system.

At S10, the evaluation engine 320 can check if there is a segment-context, and if there is an available-segment context, the engine can access the segment-context for the segment(s) that were provided at S7. The segment-context can be a model generated text-based description of information about the previously evaluated manuscript segments of the manuscript that was input at S1 that would inform an evaluation of the manuscript segment(s) from S7. The segment-context may only be available if a manuscript segment has already been evaluated, and a segment-context may not be available for the first manuscript segment that is evaluated. The segment-context can include any combination of the evaluations for image(s) and reference(s) that were accessed at S9.

At S11, the manuscript segment(s) from S7 can be evaluated. The evaluation engine 320 can evaluate the manuscript segment(s) by providing any combination of manuscript segment(s), segment-context(s), and prompt(s) as input to a generative language model. The model can evaluate the segment(s) by performing the actions specified in the prompt(s) on the segment(s) and context(s)

At S12, the segment-context can be updated or generated. In some embodiments, the evaluation engine 320 can update the segment-context by providing the context from S10 and the evaluation generated at S11 as input to a generative language model. Updating the segment-context may mean that information from the evaluation from S11 is added to the context. In some embodiments, the segment-context may have a maximum size. For example, there may be a word limit for the segment-context (e.g., 500 words, 750 words, 1000 words, or 1500 words). In some embodiments, the word limit for the segment-context can vary depending on how many manuscript segments have been evaluated (e.g., 100 words per evaluated segment). The input to the generative language model can specify the word limit for the updated context.

At S13, the evaluation engine 320 can provide the segment evaluation from S11 to the summary engine 325. The segment evaluation can be added to a summary for the manuscript (e.g., the summary for the input media file; manuscript evaluation) by the evaluation engine 320. For example, the text from the summary can be added to a text document. The summary engine 325 may create the text document in response to receiving an evaluation from the evaluation engine.

At S14, the summary engine 325 may provide the summary (e.g., the manuscript evaluation) to the client device 330. In some embodiments, the summary may be provided to the client device 330 with instructions that cause the client device 330 to display the summary. The summary can be displayed in an application that is executing on the client device 330. For example, the application can be a web browser application.

### III. Methods for Document Segmentation and Evaluation

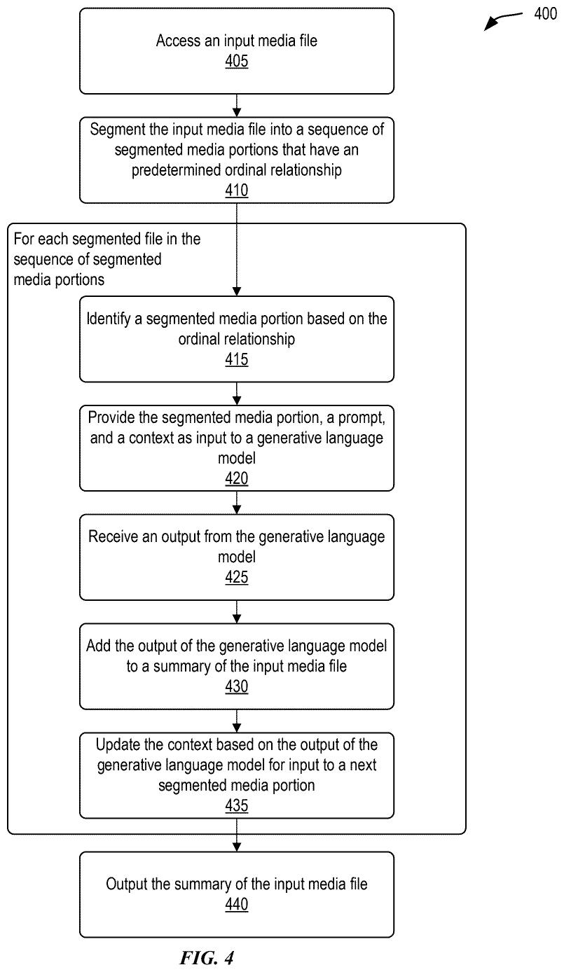

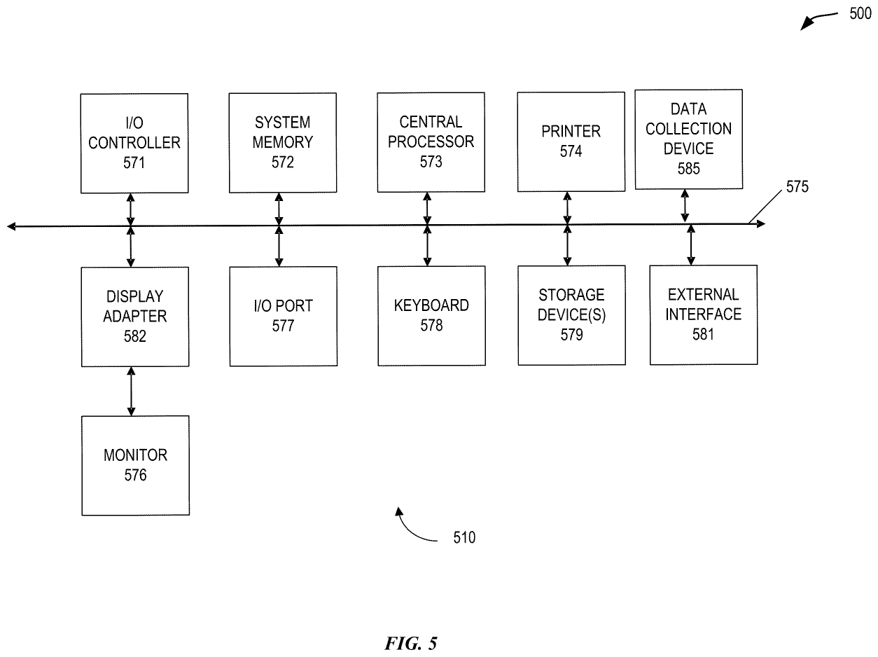

FIG. 4 is a block diagram illustrating an example method 400 for document segmentation and evaluation, in accordance with at least one embodiment. A non-transitory computer-readable storage medium may store computer-executable instructions that, when executed by at least one processor, cause at least one computer to perform instructions comprising the operations of the method 400. It should be appreciated that the operations of the method 400 may be performed in any suitable order, not necessarily the order depicted in FIG. 4. Further, the method 400 may include additional, or fewer operations than those depicted in FIG. 4. The operations of method 400 may be performed by any suitable portion the architecture shown in diagrams 100-200 of FIGS. 1-2. In some embodiments, method 400 may be executed by components of computer system 510 of FIG. 5.

At 405, an input media file can be accessed. In some embodiments, the input media file can be multiple media files. For example, a media file can be segmented before the file is input to the system and the techniques can proceed to step 415. The input media file can include any combination of at least 500 words and at least one image. Accessing the input media file can include classifying the media file, and the file may be classified based on the paper's intended audience (e.g., a particular scientific discipline). For example, the ordinal relationship from 410 can vary depending on the classification (e.g., there may be a conventional order for reading scientific manuscripts in Physics and a separate conventional order for reading scientific papers in Biology).

At 410, the input media file from 405 can be segmented into a sequence of segmented media portions (e.g., manuscript segments 108a-108n and image segments 113a-113n). The segmented media portions can have an ordinal relationship. The ordinal relationship can be predetermined, and the ordinal relationship may be provided with the input media file at 405. In some embodiments, the media file is segmented by recognizing headings within the input media file. Optical character recognition techniques can be performed on the input media file to identify text within the media file, and keyword recognition can be used to identify section headings within the input media file. The coordinates for the section headings can be recorded and used to segment the document at points that are determined based at least in part on the recorded coordinates (e.g., a horizontal line that intersects the coordinates can divide sequential media portions). In addition to keywords, the text characteristics (e.g., font, font size, and color) can be used to identify headings within the document during segmentation.

In some embodiments, the input media file can be segmented using page numbers. For example, if the methods section is on pages 3-3 of a 10-page document, the input media file can be segmented by recording the pages that contain the methods section. In some embodiments, the pages that correspond to an identified section may be copied and stored in a separate media file for the media portion. In other embodiments, the page numbers can be provided with the input media file from 405 as input to a generative language model (e.g., so the model can use the page numbers to identify the portion of the media file that corresponds to the segmented media portion without dividing the input media file into separate files).

Steps 415-335 can be performed for each segmented file in the sequence of the segmented media portions. At 415, a segmented media portion (e.g., a manuscript segment) can be identified based on the ordinal relationship from 410. The ordinal relationship can be a sequential order (e.g., the order in which the segmented media portions were identified in the input media file from 405). In some embodiments, the summary that is output at 440 can include a score for the input media file from 405 and the techniques can include iteratively varying the ordinal relationship until the score is maximized or minimized.

At 420, a segmented media portion from 415, a prompt, and a context can be provided as input to a generative language model. A prompt (e.g., prompts 111a-111n) can be information that causes a machine learning model to perform one or more operations, and the prompt can be a written description of the one or more operations in a human language. The prompt may vary between segmented media portions, and, for example, there may be a prompt for the paper's abstract section and a separate prompt for the paper's conclusion section. The prompt may be consistent between input media files or categories of input media files.

The context (e.g., segment-context 123a-123n) can provide information about images (e.g., figures) that are referenced within the segmented media portion from 415. For example, the figures that are referenced within a segmented media portion can be identified during the segmentation of the input media file at 410 (e.g., via keyword recognition). The figures can be provided as input (e.g., as image segments 113a-113n) to a machine learning model that generates a text-based description of the input figures as output (e.g., a model executing in the image engine 112). The description of the figures that are referenced in a section can be added to the segment-context for the corresponding manuscript segment.

The context for a particular segmented media portion (e.g., the segment-context 123a-123n) can include information about one or more of the other portions of the input media file. For example, the segment-context for a particular portion (e.g., segmented media portion) can include the summaries for other segmented media portions. Providing the context can include generating the context in some embodiments.

At 425, an output can be received from the generative language model. The output can be a text-based description of the segmented media portion from 415. The output may include an evaluation score for the segmented media portion. The evaluation score can be any combination of a classification (e.g., pass or fail) and a numeric score (e.g., 0-9). For example, the prompt can instruct the generative language model to classify the manuscript as ready for publication (e.g., pass) or not ready for publication (e.g., fail). The prompt may instruct the generative language model to assign a numeric to the model (e.g., a 1-10 scale score).

At 430, the output of the generative language model from 425 can be added to a summary of the input media file from 405. The summary of the input media file from 405 can be a text-based description of the file (e.g., manuscript evaluation 118), and adding the output to the summary can include creating a file that contains the summary. The summary can include an evaluation score and the evaluation score can be any combination of a classification (e.g., pass or fail) and a numeric score (e.g., 0-9). The evaluation score for the summary can be determined by combining (e.g., summing, multiplying, or averaging) the evaluation scores for some or all of the segmented media portions. The evaluation scores for the segmented media portions can be weighted to generate the summary's evaluation score in some embodiments.

At 435, the segment-context can be updated based on the output of the generative language model from 430. The segment-context can be updated for input to a next segmented media portion. The segment-context can have any combination of a maximum word limit and a minimum word limit in some embodiments. Any word limit described herein can be 50 words, 100 words, 300 words, 500 words, 750 words, 1000 words, 3000 words, 5000 words, and 10000 words.

The segment-context can be updated by providing the output from the generative language model from 430, the context from 420, and an update prompt as input to the generative language model from 420. The update prompt can include instructions that cause the generative language model to perform operations to revise the context to include information from the output of the generative language model that was received at 425. The updated segment-context can be received as output from the generative language model. Updating the context can include creating the segment-context in some embodiments. The segment-context may be updated by adding the output from the generative language model from 425 to the context (e.g., by appending the text to the end of the segment-context).

At 440, the summary of the input media file from 405 can be output. Outputting the summary can include generating a file that contains the summary. The summary can be output by displaying the summary on a display device, or providing the summary to a client device with instructions that cause the client device to display the summary.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

### IV. Improvements and Advantages

The disclosed techniques may offer technical improvements. For example, the manuscript document system may provide a written evaluation of a manuscript within a timeframe that cannot be practically performed in the human mind. A manuscript may be at least 500 words long and the manuscript document system may be able to provide a written document with an evaluation of the manuscript in one minute. The average adult reads English non-fiction at 175-300 words per minute. Marc Brysbaert, How many words do we read per minute? A review and meta-analysis of reading rate, Journal of Memory and Language, Volume 109, 3019, 104047, ISSN 0749-596X, https://doi.org/10.1016/j.jml.2019.104047. A human mind could not practically read a 500-word manuscript within one minute. Accordingly, a technique to produce a written evaluation of a manuscript within one minute cannot practically be performed in the human mind because there is not even sufficient time for the average human to read the manuscript in that timeframe. The timeframe can be 1 second, 3 seconds, 5 seconds, 40 seconds, 1 minute, 3 minutes, 5 minutes, 10 minutes, 15 minutes, 40 minutes, and 1 hour. The manuscript, or manuscript section, may be 100 words long, 350 words long, 500 words long, 1000 words long, 1500 words long, 3000 words long, 4000 words long, 5000 words long, and 10,000 words long.

Additionally, the disclosed techniques can provide a technical benefit by transforming a manuscript into a summary that is accessible to visually impaired readers. For example, manuscripts such as scientific papers may convey information through a written description and illustrative figures. A visually impaired reader may be able to read an analyze the written description using text-to-speech software. However, the written description may reference the figures, but text-to-speech software cannot provide information about the figures. Accordingly, the disclosed techniques can transform a manuscript's figures into a format that is accessible to visually impaired readers.

Furthermore, the disclosed techniques can offer a technical benefit because a shorter input to a generative language model can be evaluated with fewer computing resources. For instance, a generative language model performs natural language processing (NLP) techniques on input text to interpret the text's meaning. The generative language model may interpret each input word's meaning in light of the other words that are provided to the model. Accordingly, the computational complexity of the analysis performed by the generative language model can increase exponentially with each additional word that is input to the model. The disclosed techniques use a shortened context to provide the model with sufficient information to evaluate each section of a manuscript without having to provide the entire manuscript as input to the model. Thus, the disclosed techniques can address problems of reduced accuracy for large textual inputs. It has been shown that the performance of a generative language model can decrease as the number of words that are input to the model increases. Levy, Mosh, Alon Jacoby, and Yoav Goldberg. “Same task, more tokens: the impact of input length on the reasoning performance of large language models.” arXiv preprint arXiv: 2402.14848(2024 ).

Such a reduction of the input text can be achieved with the described ongoing summary (segment-context) that is populated between engines in the document system. A segment-context can be updated and provided with manuscript sections as input to a generative language model. The segment-context can provide a starting point (a section summary or a set of embeddings) for a generative language model so that the model can perform natural language processing to evaluate each manuscript section without providing the model with an input that includes the entire manuscript text. The segment-context may be limited to a specified character limit or word limit in some embodiments. The character limit can be 100 characters, 200 characters, 300 characters, 400 characters, 500 characters, 750 characters, 1000 characters, 1500 characters, 2000 characters, 3000 characters, 4000 characters, and 5000 characters. The word limit can be 5 words, 100 words, 200 words, 300 words, 400 words, 500 words, 1000 words, 1500 words and 2000 words. The segment-context can provide an improvement to the functioning of a computer because the context can be used to reduce the size of the input to the generative language model.

### V. Sample Prompt

Initial prompt: “What is the significance of this figure?”

Rewrite prompt: “Rewrite the given figure description to ensure it is clear, concise, and effectively integrated into the relevant section of a scientific manuscript. The description should succinctly convey the essential information and insights derived from the figure, allowing its reader to focus on its relevance to the study objectives and methodology. The rewritten text should: Briefly describe the type of figure (e.g., run chart, bar graph) and its primary purpose within the context of the study. Summarize the key data points or findings illustrated by the figure. Highlight any interventions, variables, or comparisons made in the figure, explaining their significance to the research outcomes. Clarify the implications of the figure data. The goal is to produce a description that makes the figure insights comprehensible and relevant for readers, facilitating a seamless transition to further analysis or discussion in the manuscript. Ensure the text is tailored for easy understanding and integration into a methods section that precedes detailed statistical analysis or results interpretation.”

Manuscript analysis: “abstract”: Context (C): The task involves reviewing the abstract of a scientific manuscript in the field of {rsf}. The abstract should efficiently summarize the manuscript's purpose, methodology, results, and conclusions. Output (O): The goal is to generate a professional and objective critique of the abstract, identifying areas needing improvement. The critique should be in a neutral tone, devoid of first-person references and direct addresses to the authors. Stimulus (S): Presented with the manuscript's abstract, evaluate its effectiveness in encapsulating the essence of the manuscript and its capacity to engage the intended scientific audience. Identify areas lacking in clarity or completeness. Task (T): Focus the review on specific aspects:—Evaluate the clarity and conciseness of the language.—Assess the effectiveness of the abstract in summarizing the study's purpose, methods, key findings, and conclusions, identifying any missing elements or superficial coverage.—Determine the abstract's ability to function as a standalone overview of the manuscript, highlighting any gaps or inaccuracies. Ensure the abstract is devoid of technical jargon and accessible to a broader scientific audience, suggesting necessary simplifications. The feedback should be clear, actionable, and framed in an objective manner. Actor (A): As an expert reviewer, the role is to provide a critical analysis of the abstract, approaching the task as a formal, unbiased assessment for an editorial decision, rather than personalized feedback to the manuscript's authors. Avoid use of the first-person. Response (R): Write a review that methodically addresses the criteria listed, providing constructive and specific feedback. The review should maintain a third-person, professional tone, focusing solely on the abstract's content and its efficacy in summarizing the manuscript. Avoid any personal commentary or direct engagement with the authors.

“introduction”: Context (C): The task is to review the introduction of a scientific manuscript in the field of {rsf} for publication in a peer-reviewed journal. The introduction should provide comprehensive background information, clearly state the research problem, and outline the purpose and significance of the study. Output (O): The goal is to produce a detailed, professional critique of the introduction section, focusing on its effectiveness in preparing the groundwork for the research study. Stimulus (S): With the manuscript's introduction available for review, consider the clarity, relevance, and comprehensiveness of the information presented. Task (T): Conduct an analysis of the introduction, focusing on:—Evaluating how well the background information relates to and supports the research problem.—Assessing the clarity and precision of the research problem statement.—Judging the adequacy and relevance of the literature review in establishing the significance of the research.—Commenting on the organization and logical flow of ideas. The review should provide specific insights and constructive suggestions for improvement. Actor (A): As an expert in {rsf}, the role is to offer an objective, constructive, and critical assessment of the introduction. This should be approached as a formal analysis for an editorial decision, not as personalized feedback to the authors. Avoid use of the first-person. Response (R): Write a review report on the introduction section. The report should include specific feedback and suggestions for improvement, focusing on enhancing the introduction's quality and effectiveness in setting the stage for the research. The review should be written in a third-person, professional tone, focusing on the content's merit without personal comments or direct author engagement.

“Methods”: Context (C): The task is to evaluate the methods section of a scientific manuscript in the field of {rsf}. This section is essential for detailing the research design, procedures, materials, and data analysis techniques used in the study. Output (O): The goal is to generate a detailed and professional critique of the methods section, emphasizing its thoroughness, clarity, and alignment with the research objectives. Stimulus (S): The methods section of the manuscript is provided for review. The focus should be on how effectively the section communicates the research process and facilitates replication and understanding of the study. Task (T): Conduct an assessment of the methods section, focusing on:—Evaluating the appropriateness and robustness of the research design and methodologies in relation to the study's objectives.—Assessing the clarity and comprehensiveness of the procedural descriptions.—Judging the suitability and adequacy of the materials, equipment, and resources used.—Critiquing the data analysis methods for their appropriateness, rigor, and their support of the study's findings. Provide specific examples and constructive suggestions for improvement. Actor (A): As an expert reviewer in {rsf}, the role is to offer a critical yet unbiased assessment of the methods section. Approach this as an objective analysis, focusing on the methodological rigor and clarity, without personal commentary or direct communication with the authors. Avoid use of the first-person. Response (R): Write a review report on the methods section that methodically addresses the outlined criteria. The report should provide clear, actionable feedback in a formal tone, concentrating on the scientific merits and potential areas for methodological improvement. Direct references to specific aspects of the methods section for clarification or improvement are encouraged, maintaining a professional and third-person perspective throughout the critique.

“Results”: Context (C): The task involves reviewing the results section of a scientific manuscript in the field of {rsf}. This section is expected to present data and findings accurately and clearly, in line with unbiased scientific reporting standards. Output (O): The goal is to provide a detailed critique of the results section, focusing on the precision, clarity, and scientific integrity of the data presentation. The critique should be maintained in an impersonal and professional tone, avoiding any direct addresses to the authors. Stimulus (S): Presented with the results section of the manuscript, attention should be focused on how the data is presented, ensuring it aligns with and supports the study's research questions or hypotheses. Task (T): Conduct a thorough analysis of the results section, concentrating on:—Clarity and precision in the presentation of the data, including the description of demographic and clinical data.—Appropriateness and effectiveness of the statistical analyses and visual data representations.—Consistency of the data with the study's methodology and objectives.—Impartiality in the presentation of results, ensuring that the findings are reported descriptively and without interpretation. Specific examples and constructive suggestions for improvement should be provided where necessary. Actor (A): As an experienced professional in {rsf}, the role is to offer an unbiased and critical evaluation of the results section. The review should be conducted as an objective assessment, refraining from personal comments or direct author interaction. Avoid use of the first-person. Response (R): Write a review report on the results section that methodically addresses the outlined criteria. The report should deliver constructive feedback in a formal and neutral tone, aimed at enhancing the scientific rigor and clarity of the results presentation. Including direct references to specific data points, tables, or figures for clarification or improvement is encouraged, while maintaining a professional and third-person perspective in the critique.

“Discussion”: Context (C): The task involves evaluating the discussion section of a scientific manuscript in the field of {rsf}. This section plays a critical role in interpreting the results, contextualizing them within the existing literature, and discussing the study's implications and limitations. Output (O): The goal is to produce a detailed, professional critique of the discussion section. The focus should be on its effectiveness in interpreting results, integrating with existing research, and exploring the study's implications and limitations. Stimulus (S): With the discussion section of the manuscript available for review, the emphasis should be on how the authors connect their findings to broader scientific knowledge and debates in the field. Task (T): Conduct a comprehensive assessment of the discussion section, focusing on:—Evaluating the effectiveness of the result interpretation and its contextualization within the existing body of literature.—Assessing the coherence, logic, and consistency of the arguments presented, including how they support or contrast with previous studies.—Critiquing the discussion of the study's implications, potential applications, and its significance in the field.—Reviewing the acknowledgment of the study's limitations and suggestions for areas of future research. Provide specific examples and constructive suggestions where improvements or clarifications are needed. Actor (A): As a professional reviewer with expertise in {rsf}, the role is to provide an objective, critical analysis of the discussion section. Approach this as an impartial assessment, focusing on the scientific merits of the discussion without personal commentary or direct communication with the authors. Avoid use of the first-person. Response (R): Write a review report on the discussion section, methodically addressing the outlined criteria. The report should deliver clear, actionable feedback in a formal tone, focusing on enhancing the scientific discourse and clarity of the discussion. It should emphasize the implications of the research and its integration with existing literature, with direct references to specific parts of the discussion for clarification or improvement. Maintain a professional and third-person perspective throughout the critique.

### VI. Computer System

Any of the computer systems mentioned herein may utilize any suitable number of subsystems. Examples of such subsystems are shown in FIG. 5 in computer system 510. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 5 are interconnected via a system bus 575. Additional subsystems such as a printer 574, keyboard 578, storage device(s) 579, monitor 576 (e.g., a display screen, such as an LED), which is coupled to display adapter 582, and others are shown. Peripherals and input/output (I/O) devices, which couple to I/O controller 571, can be connected to the computer system by any number of means known in the art such as input/output (I/O) port 577 (e.g., USB, FireWire®). For example, I/O port 577 or external interface 581 (e.g. Ethernet, Wi-Fi, etc.) can be used to connect computer system 510 to a wide area network such as the Internet, a mouse input device, or a scanner. The interconnection via system bus 575 allows the central processor 573 to communicate with each subsystem and to control the execution of a plurality of instructions from system memory 572 or the storage device(s) 579 (e.g., a fixed disk, such as a hard drive, or optical disk), as well as the exchange of information between subsystems. The system memory 572 and/or the storage device(s) 579 may embody a computer readable medium. Another subsystem is a data collection device 585, such as a camera, microphone, accelerometer, and the like. Any of the data mentioned herein can be output from one component to another component and can be output to the user.

A computer system can include a plurality of the same components or subsystems, e.g., connected together by external interface 581, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g. an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such devices. In addition, the order of operations may be re-arranged. A process can be terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

Computer programs typically comprise one or more instructions set at various times in various memory devices of a computing device, which, when read and executed by at least one processor, will cause a computing device to execute functions involving the disclosed techniques. In some embodiments, a carrier containing the aforementioned computer program product is provided. The carrier is one of an electronic signal, an optical signal, a radio signal, or a non-transitory computer-readable storage medium.

Any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and (ii) the components of respective embodiments may be combined in any manner.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. Furthermore, use of “e.g.,” is to be interpreted as providing a non-limiting example and does not imply that two things are identical or necessarily equate to each other.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise the term “and/or” in reference to a list of two or more items, covers all of the following interpretations of the word: any one of the items in the list, all of the items in the list, and any combination of the items in the list.

Conjunctive language such as the phrase “at least one of X, Y and Z,” unless specifically stated otherwise, is understood with the context as used in general to convey that an item, term, etc. may be either X, Y or Z, or any combination thereof. Thus, such conjunctive language is not generally intended to imply that certain embodiments require at least one of X, at least one of Y and at least one of Z to each be present. Further, use of the phrase “at least one of X, Y or Z” as used in general is to convey that an item, term, etc. may be either X, Y or Z, or any combination thereof.

In some embodiments, certain operations, acts, events, or functions of any of the algorithms described herein can be performed in a different sequence, can be added, merged, or left out altogether (e.g., not all are necessary for the practice of the algorithms). In certain embodiments, operations, acts, functions, or events can be performed concurrently, e.g., through multi-threaded processing, interrupt processing, or multiple processors or processor cores or on other parallel architectures, rather than sequentially.

Systems and modules described herein may comprise software, firmware, hardware, or any combination(s) of software, firmware, or hardware suitable for the purposes described. Software and other modules may reside and execute on servers, workstations, personal computers, computerized tablets, PDAs, and other computing devices suitable for the purposes described herein. Software and other modules may be accessible via local computer memory, via a network, via a browser, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, interactive voice response, command line interfaces, and other suitable interfaces.

Further, processing of the various components of the illustrated systems can be distributed across multiple machines, networks, and other computing resources. Two or more components of a system can be combined into fewer components. Various components of the illustrated systems can be implemented in one or more virtual machines or an isolated execution environment, rather than in dedicated computer hardware systems and/or computing devices. Likewise, the data repositories shown can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Embodiments are also described above with reference to flow chart illustrations and/or block diagrams of methods, apparatus (systems) and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention. These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates other aspects of the invention in any number of claim forms. For example, while only one aspect of the invention is recited as a means-plus-function claim under 45 U.S.C sec. 112(f) (AIA), other aspects may likewise be embodied as a means-plus-function claim, or in other forms, such as being embodied in a computer-readable medium. Any claims intended to be treated under 45 U.S.C. § 112(f) will begin with the words “means for,” but use of the term “for” in any other context is not intended to invoke treatment under 45 U.S.C. § 112(f). Accordingly, the applicant reserves the right to pursue additional claims after filing this application, in either this application or in a continuing application.

What is claimed is:

1. A method comprising:
accessing an input media file;
segmenting the input media file into a sequence of segmented media portions that has a predetermined ordinal relationship between each segmented media portion of the sequence of segmented media portions; and
for each segmented media portion in order in the sequence of segmented media portions:
identifying the segmented media portion based on the predetermined ordinal relationship;
providing, as input to a generative language model, the segmented media portion, a prompt, and a context when present;
receiving an output from the generative language model;
adding the output of the generative language model to a summary of the input media file; and
updating the context based at on the output of the generative language model for input to a next segmented media portion of the segmented media portions;
outputting the summary of the input media file.

2. The method of claim 1, wherein updating the context for input to the next segmented media portion comprises:
providing the output of the generative language model, the context, and an update prompt for a previous segmented media portion as input to the generative language model;
receiving an updated context as output from the generative language model, wherein the updated context is the context for the next segmented media portion of the segmented media portions.

3. The method of claim 1, wherein providing the context as input to the generative language model comprises:
identifying one or more figures that are referenced in the segmented media portion;
providing the one or more figures as input to an image model that is trained to output a text-based summary of an input figure;
receiving one or more text-based summaries that correspond to the one or more figures; and
adding the one or more text-based summaries to the context.

4. The method of claim 1, wherein the output from the generative language model comprises at least one of a summary of the segmented media portion and an evaluation score of the segmented media portion.

5. The method of claim 4, wherein the prompt comprises natural language instructions that cause the generative language model to perform operations to generate at least one of the summary of the segmented media portion and the evaluation score of the segmented media portion.

6. The method of claim 1, wherein the input media file comprises at least 1000 words and the summary of the input media file comprises at least 500 words.

7. The method of claim 6, wherein the method is performed within one minute.

8. A computing device, comprising:
one or more memories; and
one or more processors in communication with the one or more memories and configured to execute instructions stored in the one or more memories to perform operations to:
access an input media file;
segment the input media file into a sequence of segmented media portions that has a predetermined ordinal relationship between each segmented media portion of the sequence of segmented media portions; and
for each segmented media portion in order in the sequence of segmented media portions:
identify the segmented media portion based on the predetermined ordinal relationship;
provide, as input to a generative language model, the segmented media portion, a prompt, and a context when present;
receive an output from the generative language model;
add the output of the generative language model to a summary of the input media file; and
update the context based at on the output of the generative language model for input to a next segmented media portion of the segmented media portions;
output the summary of the input media file.

9. The computing device of claim 8, wherein updating the context comprises operations to:
provide the output of the generative language model, the context, and an update prompt as input to the generative language model;
receive an updated context as output from the generative language model, wherein the updated context is the context for the next segmented media portion of the segmented media portions.

10. The computing device of claim 8, wherein providing the context as input to the generative language model comprises operations to:
identify one or more figures that are referenced in the segmented media portion;
provide the one or more figures as input to an image model that is trained to output a text-based summary of an input figure;
receive one or more text-based summaries that correspond to the one or more figures; and
add the one or more text-based summaries to the context.

11. The computing device of claim 8, wherein the output from the generative language model comprises at least one of a summary of the segmented media portion and an evaluation score of the segmented media portion.

12. The computing device of claim 11, wherein the prompt comprises natural language instructions that cause the generative language model to perform operations to generate at least one of the summary of the segmented media portion and the evaluation score of the segmented media portion.

13. The computing device of claim 8, wherein the input media file comprises at least 1000 words and the summary of the input media file comprises at least 500 words.

14. The computing device of claim 13, wherein the operations are performed within one minute.

15. A non-transitory computer-readable medium storing a plurality of instructions that, when executed by one or more processors of a computing device, cause the one or more processors to perform operations to:
access an input media file;
segment the input media file into a sequence of segmented media portions that has a predetermined ordinal relationship between each segmented media portion of the sequence of segmented media portions; and
for each segmented media portion in order in the sequence of segmented media portions:
identify the segmented media portion based on the predetermined ordinal relationship;
provide, as input to a generative language model, the segmented media portion, a prompt, and a context when present;
receive an output from the generative language model;
add the output of the generative language model to a summary of the input media file; and
update the context based at on the output of the generative language model for input to a next segmented media portion of the segmented media portions;
output the summary of the input media file.

16. The non-transitory computer-readable medium of claim 15, wherein updating the context comprises operations to:
provide the output of the generative language model, the context, and an update prompt as input to the generative language model;
receive an updated context as output from the generative language model, wherein the updated context is the context for the next segmented media portion of the segmented media portions.

17. The non-transitory computer-readable medium of claim 15, wherein providing the context as input to the generative language model comprises operations to:
identify one or more figures that are referenced in the segmented media portion;
provide the one or more figures as input to an image model that is trained to output a text-based summary of an input figure;
receive one or more text-based summaries that correspond to the one or more figures; and
add the one or more text-based summaries to the context.

18. The non-transitory computer-readable medium of claim 15, wherein the output from the generative language model comprises at least one of a summary of the segmented media portion and an evaluation score of the segmented media portion.

19. The non-transitory computer-readable medium of claim 18, wherein the prompt comprises natural language instructions that cause the generative language model to perform operations to generate at least one of the summary of the segmented media portion and the evaluation score of the segmented media portion.

20. The non-transitory computer-readable medium of claim 15, wherein the input media file comprises at least 500 words and the summary of the input media file comprises at least 500 words.
